(19) United States
(12) Patent Application Publication
(10) Pub. No.: US 2024/0232959 A1
(43) Pub. Date: Jul. 11, 2024

(54) SYSTEM FOR THE MANAGEMENT OF VERIFIED REVIEWS AND METHOD THEREOF

(71) Applicants: Lorenzo VESENTINI, San Giorgio de Mantova (IT); Patrizio OLIOSI, Porto Mantovano (IT); Andreas MARTIN, Monaco (DE)

(72) Inventors: Lorenzo VESENTINI, San Giorgio de Mantova (IT); Patrizio OLIOSI, Porto Mantovano (IT); Andreas MARTIN, Monaco (DE)

(21) Appl. No.: 18/563,106

(22) PCT Filed: May 20, 2022
(86) PCT No.: PCT/IB2022/054721

§ 371 Date: Nov. 21, 2023

(30) Foreign Application Priority Data
May 21, 2021 (IT) 102021000013322

(51) Int. Cl. G06Q 30/0282; G06Q 20/40

(52) U.S. Cl. CPC G06Q 30/0282; G06Q 20/401

(57) ABSTRACT

The present invention concerns a system and method for managing the release of reviews wherein it is intended to generate at least one unique, non-reusable review code, which can be used by the customer to issue a review relating to products and/or services purchased from a supplier, and wherein there is a review storage system configured to handle a review request from a customer that comprises at least one unique review code.

The present invention relates to a system and method for issuing verified reviews following a certified purchase of goods or services from a supplier.

Customer reviews and ratings of third-party goods and services have long been widely used in commerce.

These reviews allow a “customer” to review the quality or performance of products and/or services purchased/received from shops, craftsmen, professionals and generally from any kind of business or enterprise, hereinafter referred to generically as “supplier(s)”.

These reviews can be useful feedback for suppliers to help them improve their products and services or their performance (for example, the quality of their customer service).

Reviews are, however, even more useful as a source of apparently objective information for potential customers, or consumers, about the products/services or the providers themselves.

In recent years, several third-party companies have been established to meet this need, namely to serve as an objective and impartial repository of customer reviews and ratings.

The growing propensity to use the internet for commerce and the exponential increase of online activities have led to a consequent increase of online review platforms managed directly by the same companies that offer goods and/or services (such as “amazon.com”, to name one of the most famous) as well as autonomous third parties platforms, (for example, “yelp.com”, “tripadvisor.com”, “trustpilot.com”, etc.).

Most known platforms, however, through the distributed and decentralized nature of the Internet allow users to generate and submit online reviews instantly, even anonymously, from anywhere in the world. In addition, since such online reviews are almost always received, stored and processed by computer systems that are managed by and under the control of a single entity (be it the provider itself or a third-party review platform), anyone can see how the online review industry is particularly vulnerable to abuse of fake, biased and manipulated reviews.

As a result, many consumers today believe that they cannot rely on reviews of the products and services they see online.

It is well known that many, or almost all, conventional online review platforms can be manipulated by interested parties for various purposes such as reviewing a supplier from whom they have not purchased any product or service, sending reviews about themself or their products with high scores, fake reviewing a competitor, paying “third-party review companies” to write favourable reviews for their company's products or services, or paying providers of seemingly objective third-party review platforms to eliminate or hide negative reviews relating to a supplier's product or service.

In addition, the use of known platforms requires a registration by the customer providing personal data.

Patent application WO 2019/099936 A1 describes a system and method by which it is possible to identify a supplier available to perform a certain task at a location selected by a user, to hire the chosen supplier to perform the task at the selected location, and, once the supplier's task is completed, the customer can make a review of the work performed. The platform described by this document is configured to verify the authenticity of the customer's review for the particular supplier and the activity performed and to ensure that it cannot be modified, deleted or manipulated by third parties.

These known systems and methods, however, have certain limitations and disadvantages.

The system in question requires that the service provision must necessarily be chosen and booked through the same platform that also manages all customer reviews. This system is consequently inflexible since, as it is configured, it can only be used by providers who decide to offer their services via this platform. This can be impractical or limiting for many activities.

In addition, the suppliers who decide to use this system, if they do not use it exclusively to provide their products/services, they can only obtain reviews from customers who decide to use the same platform to make their purchase or booking.

US 2020/219152 A1 describes a system for the integration of online reviews with POS and EPOS systems comprising a server and a point-of-sale system to complete a transaction between a company and a customer where the point-of-sale system sends information about the transaction to the server.

A code is generated by the server in response to receiving the transaction information, the code associated with the transaction, the server sends the code to the point of sale system. A receipt for the transaction is printed by the point-of-sale system, the receipt comprising the code. A user computer is handled by the customer, this user computer has a scanner that scans the receipt to identify the code, this user computer sends the code to the server.

The server validates the code received from the user's computer to confirm that the transaction has taken place between the customer and the company. A review of the business is created by the customer, the user's computer receives the review and sends the review to the server only after the code has been validated. The server publishes the review to the users of the system.

This system partly solves the problems mentioned above, but can nevertheless be improved. In fact, the system can verify that the review is only issued by those who have the unique code. However, there is no system to verify the inalterability of the data on the system server, in particular the review.

With this well-known system, there is also the need to protect the unique code in order to avoid reconstruction from the transaction information of the purchase against which a review is to be permitted, which could be accessible to unauthorized parties.

In order to prevent such events, i. e. the review from being altered or generated using a fraudulently reconstructed unique code, the system must be configured with security systems that make it more complex and expensive to implement and manage. There is therefore a need in the industry to have a system and a method for issuing reviews on purchased products or services that go beyond the limits of the known technique.

The aim of the present invention is therefore to provide a system and a method allowing a user “customer” to give a review for products or services purchased/received by a “supplier” which is linked to a certified purchase and which cannot be manipulated after its issue and, therefore, can be considered reliable by those who consult it.

In particular, it is the purpose of the present invention to provide a system, and its method, designed in such a way as to ensure that only the customer who has actually purchased the products or services from a given supplier can issue a single review.

Another purpose of the present invention is to provide a system and method to implement a review platform suitable for reviewing products or services of all kinds from suppliers in virtually any sector.

The aim of the present invention is also to create a review platform that can be used to review products or services purchased online or at shops or physical activities.

It is also an additional aim of the present invention to provide a system that makes reviews submitted by a customer unalterable after they have been created.

Finally, it is within the scope of the present invention to provide a review platform by which a customer can interact, by issuing reviews, without having to provide personal data to third parties.

These and other purposes are achieved by a system for releasing verified reviews in accordance with claim 1.

According to the present invention the system comprises a review storage and management device and a purchase receipt generation device, usable by a supplier, configured to exchange data with the first device over the internet.

The purchase receipt generation device is also configured to generate a purchase receipt for the customer, where the purchase receipt comprises at least a unique review code through which the customer can send a review request to the review storage and management device. The purchase receipt may also comprise other details of the products and/or services purchased from the supplier, such as a supplier's identifier, a unique identifier of the purchase, the time and date of purchase, a description of the goods or services purchased and the type of payment used.

After a purchase of a product or service, the purchase receipt generation device is configured to send to the review storage and management device at least the supplier's identifier and the unique purchase code. Preferably, the purchase receipt generation device may also send to the review storage and management device the time and date of the purchase, a description of the goods or services purchased, information regarding the payment method used, and possibly the geographic location of the supplier, in the case of a purchase of goods or services at a physical commercial establishment, or the address of the customer, in the case of purchases made online.

According to an embodiment of the present invention, the unique review code may be generated by the review storage and management device or by the purchase receipt generation device.

In the first case, after generation, the code is sent to the purchase receipt generation device which, in turn, generates the purchase receipt for the customer comprising at least said unique review code.

In the second case, instead, the purchase receipt generation device directly generates the purchase receipt comprising at least one unique review code.

In both cases, the storage device is configured to associate a given unique review code with a unique purchase identifier.

According to the invention, the review storage and management device is further configured to receive a review release request from a customer. For each review release request, the customer is requested to provide at least one unique review code. The review storage and management device is configured to verify that the unique review code of the request matches the unique purchase identifier and, in case of a match, verifies that there are no stored reviews already associated with that unique purchase identifier. In the event of a positive verification, the review storage and management device stores the customer's review of the product(s) and/or service(s) purchased from the supplier. This review storage and management device also makes this review accessible for reading, typically through an electronic device connected to the Internet.

Preferably, in addition to the review of the goods and/or services, the review storage and management device also makes available, and associated with the review, the supplier identifier and possibly the time and date of the purchase, the geographical location, the description of the goods and/or services purchased, the type of payment used.

According to the invention, the review storage and management device is implemented with a preferably public blockchain. Such a system configuration ensures that the data stored by the review storage and management device, in particular reviews provided by customers, cannot be altered once created.

Furthermore, according to the invention, the unique review code is associated with the unique purchase identifier through an encryption algorithm or through hash functions.

In particular, this encryption algorithm can use asymmetric key cryptography or symmetric key cryptography.

In the first case there are two keys, one public and one private. With the public key, it is only possible to decrypt the unique code in order to obtain the purchase identifier while the private key is needed to encrypt the purchase identifier in order to obtain the unique code.

In the second case, on the other hand, there is only one key, necessarily private, through which it is possible to encrypt the purchase identifier in order to obtain the unique code and decrypt the unique code in order to derive the purchase identifier.

In both cases, without the private key, it is not possible to obtain the unique code from the purchase identifier.

Any symmetric or asymmetric key encryption algorithm can then be adopted, such as 3DES, AES, RSA, Diffie-Elman, El-Gamal.

If the device uses a hash function, any hash function can be used for this purpose, such as sha-2, MD5, Lyra, etc.

This prevents an unauthorized third party from reconstructing the unique review code from the purchase identifier in order to issue the review instead of the legitimate customer. The unique purchase identifier data is therefore information that can be freely accessed by third parties, such as in the case where the system is based on a public blockchain, and that does not require any special security criteria in the transmission from the receipt generation device to the review management and storage system. The above-mentioned purposes are further achieved by a method, implementable with a system as described above, in accordance with claim 8.

According to the invention, the method comprises at least the following steps:
a) generate a unique identifier of a purchase for at least one product or service from a customer to a supplier;
b) generate at least one unique review code associated with the purchase identifier using an encryption algorithm or hash function;
c) generate, with a purchase receipt generation device, a purchase receipt comprising at least:
   the unique review code associated with the unique purchase identifier;
   and preferably also one more of the following data:
   the unique identifier of the purchase;
   an identifier of the supplier;
   the time and date of purchase;
   the geographical location of the supplier or customer or both;
   a description of the goods or services purchased;
   information on the method of payment used;
d) provide purchase receipt information to the customer;
e) send to a review storage and management device at least the following data
   the unique identification of the purchase;
   supplier's identification data;
   and preferably also:
   the time and date of purchase;
   the geographical location of the supplier or customer or both;
   a description of the goods or services purchased
   information on the method of payment used;
f) Store in the distributed review storage and management device on a blockchain the data from the previous step;
g) receive a review request from a customer's electronic device where that request comprises at least the unique review code provided with the purchase receipt;
h) verify that the unique review code of the request matches the unique purchase identifier stored in the review storage and management device;
i) check whether reviews associated with this unique identifier are already stored;
j) receive and store in the review storage and management device the customer's review on at least one product or service purchased by the provider;
k) make the review associated with at least the seller's identification data and possibly one or more of the other data listed under e) available for reading.

It is specified that the above-mentioned steps can be carried out in the order submitted or in a different order. In particular, step b) consisting in generating the unique review code may be performed before, after or at the same time as step e) of sending the information to the review storage and management device.

More in detail, if the unique review code is generated directly by the purchase receipt generation device, step b) may take place before step e).

If the unique review code is generated by the review storage and management device, step (b) occurs after step (e) because the unique review code generation requires that the unique purchase identifier, transmitted by the purchase receipt generation device after the purchase has taken place, be stored in the review storage and management device.

The system and method of the present invention enable a platform for reviews of goods and/or services to be set up which is independent of the suppliers and the way in which the goods and/or services are sold.

The system and method configured in this way, moreover, compared to those of the known technique, ensure that a stored review is always associated with a purchase actually made from a given identified supplier. In addition, a unique review code can be used to make a single review request, which once stored on the blockchain, cannot be modified by the customer himself.

With the system and method of the present invention, it is also possible to guarantee that the customer can issue an authentic review without being required to register and, therefore, without providing any personal data. This ensures maximum privacy of customers and may incentivise the release of reviews.

According to one aspect of the invention, the device for generating purchase receipts may be, for example, a physical cash register, a computer apparatus, or any other electronic device of the vendor that is connected to the Internet and is capable of exchanging data over the network, in particular receiving from and/or sending to the review storage and management device the information listed above.

The purchase receipt can be a printout on a paper medium or a digital message sent to the customer through traditional communication systems such as e-mail, SMS, etc., and readable through a customer's electronic device such as a smartphone, tablet, computer or the like.

The system and method according to the present invention are practically employable both by businesses or commercial activities operating with physical facilities, such as shops, restaurants, bars, clubs, hotels, gyms, etc., and by activities also or exclusively operating at a distance, for example through e-commerce or equivalent commercial platforms.

According to one aspect of the invention, the unique review code can be a string of alphanumeric characters, a linear or two-dimensional (or matrix) bar code such as a “QR code” or equivalent codes.

According to another aspect of the invention, where a single purchase, combined with a unique purchasing identifier comprises several products and/or services, the device for generating purchase receipts may be configured to generate a detailed description of those individual products and/or services and to send those descriptions to the device for storing and managing reviews.

According to this variant, the device generating the unique review code, whether it is the purchase receipt generation device or the review storage and management device, can generate multiple unique review codes specific to the individual products and/or services purchased, which are provided to the customer through the purchase receipt. The process of generating and managing the specific review codes is identical to that for the unique review code of the purchase. Each specific code is associated by the review storage and management device at least with the unique purchase identifier, the supplier data and possibly the other data mentioned above.

The modalities of issuing and reviewing are also substantially identical to those described above. The review storage and management device, upon receipt of a review request from a customer for a specific product or service of a multiple or cumulative purchase, will verify the association between the specific unique review code and the unique purchase identifier among those stored, will verify that there are no associated reviews already stored and, in case of positive verification, will store the customer's review making it available in the manner described above.

This variant of the invention makes it possible to generate independently verified reviews for each product or service purchased, always guaranteeing the actual purchase by the customer.

The variant described above can be used, for example, to independently review the different courses of a meal, drinks or even the service in a restaurant or, as mentioned above, to individually review different products purchased from the same supplier.

If applicable, where the payment method is information stored by the review storage and management device, the system may generate a review sub-code to issue a review also regarding the payment process.

The system can be configured to generate both a unique review code for the purchase as a whole and a number of specific review sub-codes for the individual products and/or services purchased.

According to this variant, the customer can choose to leave a review for each product and/or service or leave a single overall cumulative review.

The system according to the present invention achieves a considerable level of reliability that is significantly higher than known systems because, in addition to allowing only a review request associated with a unique review code, and protecting the reconstruction of that code by generating it through an encryption algorithm, it makes reviews no longer modifiable by third parties, not even the operator of the review platform.

Accordingly, with the system and method of the present invention, the above-mentioned malpractices, which are possible today with most third-party review platforms, would be categorically prevented.

According to another aspect of the invention, the review storage and management device can be implemented with an algorithm configured to analyze the content of the customer's review. This algorithm can be comprised in software or implemented through a neural network.

According to a preferred variant, this algorithm can be configured to compare the description of purchased goods and services provided by the purchase receipt generation device with the description of goods and/or services comprised in the review text and to classify the review as consistent or inconsistent.

If the customer accidentally, or voluntarily, leaves a review for products and/or services that do not match those actually purchased, the algorithm may classify the review as inconsistent and the review storage and management device may block or revoke the review.

According to another aspect of the invention, the review storage and management device can be configured to set a time limit for customer review release. This time period is usually dependent on the nature of the goods and/or services purchased.

According to this variant, the review storage and management device can be implemented with an algorithm configured to classify the purchased products or services according to a predetermined list of product and service categories, each of which is assigned a time limit for review release. The algorithm is then configured to perform a check between the purchase date and the review request date, and to prevent the review from being released when the request date is beyond the set time limit.

This feature allows automatic filtering of reviews that would most likely be incorrect or inaccurate due to time elapsed since purchase.

For example, an objective review for an item purchased could be issued even after several months when the customer could appreciate its functionality, quality and durability.

On the contrary, for example, with regard to a meal eaten at a restaurant, it is likely that after many months the customer may not accurately remember the quality of the food eaten and the service received.

Further features and advantages of the present invention will become clearer from the description of an embodiment example as illustrated in the attached figures wherein:

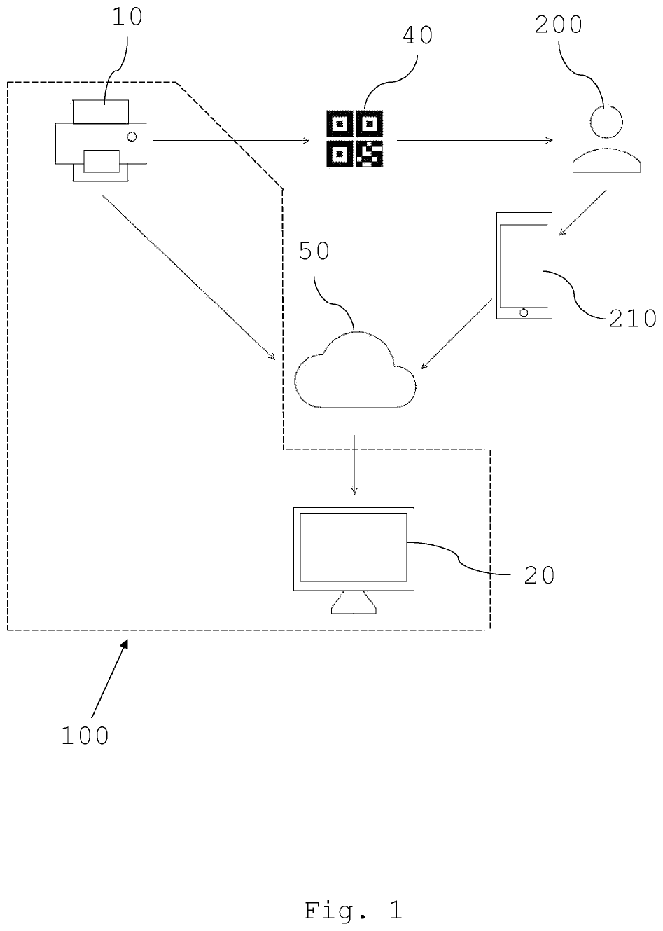

FIG. 1 is a schematic representation of the system for managing verified reviews according to the present invention;

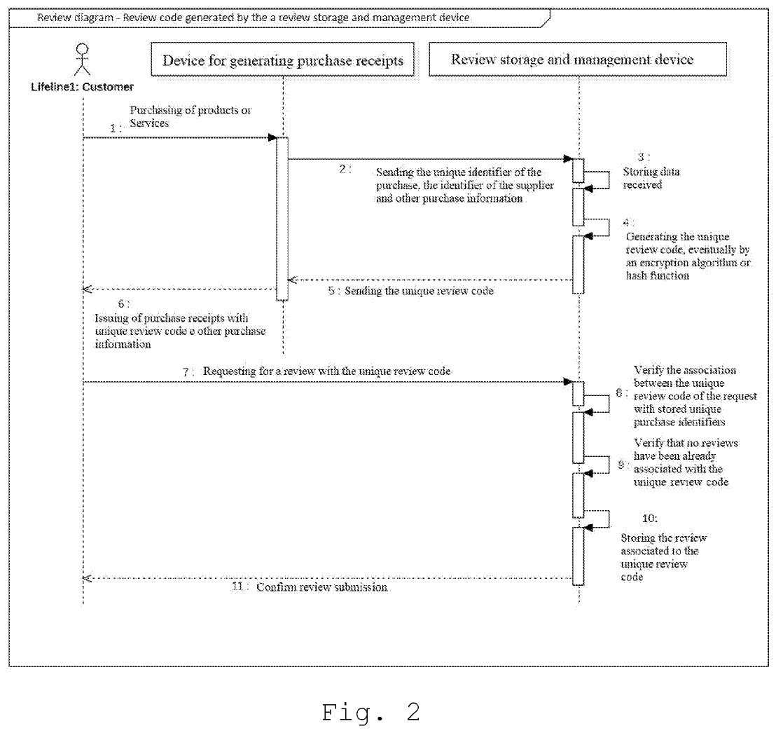

FIG. 2 is an embodiment of a flow diagram illustrating the operation of the system according to a variant of the present invention;

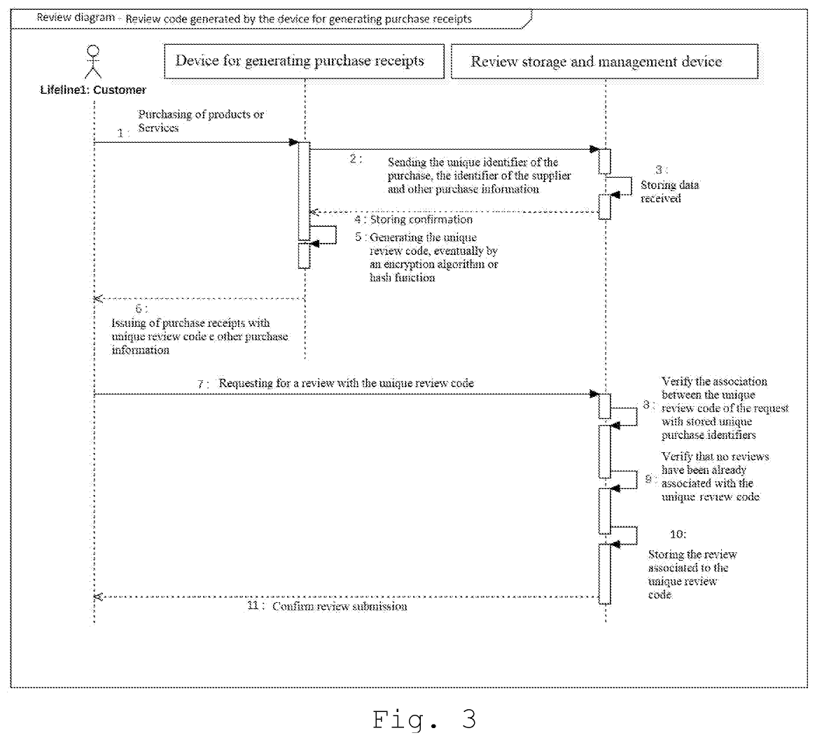

FIG. 3 is an embodiment of a flow diagram illustrating the operation of the system according to another variant of the present invention;

With reference to the attached FIG. 1, the system for issuing verified reviews according to the invention is indicated in the aggregate by the number 100. The system 100 comprises a device for generating purchase receipts 10 and a device for storing and managing reviews 20. As mentioned above, Purchase Receipt Generation Device 10 is a device used by the supplier of the products and/or services through which the supplier can, among other things, generate the purchase receipt for the customer. The Purchase Receipt Generator 10 is typically a cash register or a computer, a mobile device (tablet or smartphone), equipped with a data communication module capable of connecting to an internet network 50.

The review storage and management device 20 is distributed on a blockchain. The review storage and management device 20 is therefore an IT apparatus that can be operated by a different entity than the providers of the products and/or services and that provides a platform for the issuing of reviews of products and/or services purchased from suppliers that are affiliated to that platform.

In particular, a supplier's purchase receipt generation device 10 is configured to communicate with the review storage and management device 20 via the internet network 50 to exchange all the data required for the review process.

FIG. 1 also shows a customer 200 which can interact with the system 100. More specifically, the customer 200 can receive from the Purchase Receipt Generator 10 the Purchase Receipt 40 containing the unique review code and possibly the other data mentioned above. As specified earlier, the purchase receipt 40 can be delivered directly to the customer 200 by the supplier if it has a physical entity, a receipt, a printout, etc. or made accessible to the customer via an electronic device if it is in electronic form.

The customer 200 also interacts with the review storage and management device 20, through an electronic device 210 connected to the internet network 50, to make a review request for one or more purchased products and/or services.

With reference to FIG. 2, a flow diagram of the data generation and storage process used by the system 100 for managing reviews is illustrated, according to one embodiment of the invention.

After a purchase has been made by a customer 200 from a supplier, the purchase receipt generation device 10 transmits data relating to the purchase to the review storage and management device 20 via the internet network 50. In accordance with a preferred variant, this data comprises at least an identifier of the supplier, a unique identifier of the purchase, the time, date and geographical location of the purchase, a description of the products and/or services purchased and the payment method used. If there are several products and/or services in the individual purchase, preferably the purchase receipt generation device 10 sends to the review storage and management device 20 a description of each individual product and/or service.

The review storage and management device 20, stores this data in a storage unit built on a blockchain.

The review storage and management device 20, for example by means of a symmetric key encryption algorithm or hash function of the aforementioned types, generates, from the unique identifier of the purchase, a unique review code. Where the purchase comprises multiple products and/or services, the review storage and management device 20 is configured to generate multiple review codes specific to each product and/or service. The review storage and management device 20 stores in the memory unit the unique purchase identifier and, if applicable, the specific unique purchase identifier associated with the respective product or service descriptions.

The review storage and management device 20 then sends the one or more unique review codes to the purchase receipt generation device 10. The purchase receipt generation device 10 generates a purchase receipt for the customer which comprises at least the one or more unique review codes, preferably associated with the respective product or service description, and typically also the supplier identifier and the time, date and geographic location of the purchase. The receipt can, of course, comprise any other information related to the purchase such as the amounts of the products and/or services purchased, other tax information, etc.

As previously mentioned, the receipt can be sent to the customer as an electronic document, e.g. by e-mail, SMS or via a supplier's e-commerce platform, or physically delivered to the customer as a printed document.

The customer 200, at this point, can make a review request through its own electronic device 201 configured to connect to the Internet 50.

The review request is typically made through a web page of the review platform or through an application installed on the electronic device, enabling communication with the review storage and management device 20.

In the review request, in addition to the text of the review, the customer also provides the general or specific unique review code for a particular product or service of a multiple purchase.

The review storage and management device 20 verifies that the unique review code is associated with a unique purchase identifier in the storage unit and that there is not already a stored review associated with that identifier or code. How the association is verified depends primarily on the encryption method used to generate the unique review code. In any case, the unique review code cannot be derived retrospectively from the unique purchase identifier.

In case of a successful verification, the review storage and management device stores the text of the review and sends a confirmation to the device 201 of the customer 200. In case a review is already stored, the review storage and management device 20 interrupts the storage process and sends a rejection message to the device 201 of the customer 200. In FIG. 3, a flow diagram of the data generation and storage process is illustrated according to another embodiment of the invention.

The operation of the system 100 according to this variant is similar to that described above. The main difference is in the device that generates the one or more unique review codes.

According to this variant, in fact, it is the purchase receipt generation device 10 that, again by means of an encryption algorithm, in this case for example asymmetric key or hash function of the aforementioned types, directly generates the unique review code and possibly the specific review codes for the individual products and/or services of a multiple purchase.

The purchase receipt generation device 10 then sends all purchase data and the one or more unique purchase identifier(s) to the review storage and management device 20. The review storage and management device 20 stores the purchase data and the unique purchase identifiers in the memory unit in substantially the same manner as described for the variant described above. Preferably, the review storage and management device 20 sends a confirmation of correct storage to the purchase receipt generation device 10.

The steps of issuing the purchase receipt to the customer and requesting a review are unchanged from the variant of FIG. 2.

The invention has been described for illustrative and non-limiting purposes, according to certain preferred forms of implementation. Numerous other forms of implementation and variations may be found by the person skilled in the art, all of which fall within the scope of protection of the following claims.

1. A system for issuing verified reviews for a purchase of products and/or services from a supplier comprising: a review storage and management device implemented with a blockchain, connected to an internet network and configured to transmit and receive data via said internet network; a device for generating purchase receipts, usable by a supplier, which is a) communicating with the review storage and management device via the internet network; and b) configured to generate a purchase receipt following a purchase of at least one product or service made by a customer from the supplier and to provide a purchase receipt to the customer, wherein the purchase receipt comprises at least one unique review code, associated with a unique purchase identifier, and preferably also one or more of the following data an identifier of the supplier; the unique identifier of the purchase; —the time and date of purchase; a description of the goods or services purchased; where this storage and review management device is configured to: receive from the purchase receipt generation device at least the following information relating to a purchase made by a customer: a) the supplier's identifier, b) the unique identifier of the purchase; and preferably also one or more of the following data: c) the time and date of the purchase; d) the geographical location of the supplier or customer or both; e) the description of the goods or services purchased f) the type of payment used; —store this information associated with the unique purchase identifier; receive, through the Internet, a review request from a customer's electronic device where the review request comprises at least the unique review code; verify the correct association between the unique review code of the request with a unique purchase identifier from the stored ones; verify that a review associated with the unique purchase identifier associated with the unique request review code has not already been stored; store the customer's review of at least one product or service purchased by the supplier; where at least one unique review code is generated by the review storage and management device and then sent to the purchase receipt generation device or it is generated directly by the purchase receipt generation device, and where the purchase receipt generation device or review storage and management device is configured to generate that unique review code from the unique purchase identifier, through an encryption algorithm or hash function.

2. The system according to claim 1, where the purchase receipt generation device is configured to generate a detailed description for each individual product and/or service of a multiple purchase comprising multiple products and/or services and to send those descriptions to the storage and review management device, where the storage and review management device is configured to store the descriptions of individual products and/or services and associate them with the unique purchasing identifier, where the purchase receipt generation device or the storage and review management device is configured to generate multiple unique review codes specific to the individual products and/or services purchased, and where the purchase receipt generation device is configured to generate a purchase receipt that comprises those unique review codes

3. The system according to claim 1, where the review storage and management device can be implemented with an algorithm configured to analyze the content of the customer review, in particular to compare the description of the goods and/or services purchased provided by the purchase receipt generation device with the products and/or services described in the review text and to classify the review as consistent or inconsistent.

4. The system according to claim 1, where the review storage and management device is implemented with an algorithm configured to classify purchased products and/or services according to a predetermined list of product and service categories each of which is assigned a review release time limit and where that review storage and management device is configured to associate the unique purchase identifier with a limit date for a review request and to check whether the review request date is prior to the review request limit date.

5. A method for issuing verified reviews for a purchase of products and/or services from a supplier, this method being implemented with a system according to any of the preceding claims, the method comprising at least the following steps: a) generate a unique purchase identifier related to at least one product and/or service made by a customer from a supplier; b) generate at least one unique review code associated with the purchase identifier through an encryption algorithm or a hash function; c) generate, with a purchase receipt generation device, a purchase receipt containing at least: the unique review code associated with the unique purchase identifier; and preferably also one or more of the following: the unique purchase identifier; an identifier of the supplier; the time and date of purchase; the geographical location of the supplier or customer or both; a description of the goods or services purchased information on the payment method used; d) provide the purchase receipt information to the customer; e) transmit to a review storage and management device at least the following data: the purchase's unique identifier supplier's identification data; and preferably also one or more of the following data: the time and date of purchase; the geographical location of the supplier or customer or both; a description of the goods or services purchased; information on the payment method used; f) store the data from the previous step in the review storage and management device implemented with a blockchain; g) receive a review request from a customer's electronic device where said request comprises at least the unique review code provided with the purchase receipt; h) verify that the request's review code matches a unique purchase identifier stored in the review storage and management device; i) check whether reviews associated with this unique identifier are already stored; j) receive and store in the review storage and management device the customer's review of at least one product or service purchased from the supplier; k) provide the review associated with at least the seller's identification data and possibly one or more of the other data listed under (e) for reading.

6. The method according to claim 5, where, after or at the same time as step (a), a detailed description for each individual product and/or service of a multiple purchase comprising several products and/or services is generated and these descriptions are sent to the review storage and management device associated with the unique purchase identifier, and where at step (b) multiple unique review codes are generated specific to the individual products and/or services purchased that are associated with unique purchase identifiers stored in the review storage and management device and associated with the respective description of the products and/or services purchased.

7. The method according to claim 5, where it is planned to compare the description of the goods and/or services purchased provided by the purchase receipt generation device with the goods and/or services described in the text of the review and to classify the review as either consistent or inconsistent.

8. The method according to claim 5, where it is planned to classify the purchased goods and/or services according to a pre-established list of categories of goods and services, to assign to each category a time limit for a review, to associate the unique purchase identifier with a time limit date for a review request, and to check whether the review request date is prior to the time limit date.
